(19) United States
(12) Patent Application Publication
(10) Pub. No.: US 2006/0117186 A1
(43) Pub. Date: Jun. 1, 2006

(54) Entrance and exit management system

(76) Inventor: Tae-Soon Yeo, Kyunggi-do (KR)

Correspondence Address: YOUNG & THOMPSON, 745 SOUTH 23RD STREET, 2ND FLOOR, ARLINGTON, VA, 22202, US

(21) Appl. No.: 10/514,482

(22) PCT Filed: May 16, 2003
(86) PCT No.: PCT/KR03/00972

§ 371 Date: Nov. 16, 2004

(30) Foreign Application Priority Data
May 16, 2002 (KR) 10-2002-0027086

(51) Int. Cl. H04L 9/00

(52) U.S. Cl. 713/182; 705/5

(57) ABSTRACT

An entrance and exit management system allows a passenger having a reservation ticket to instantly get into an airplane by automatically ascertaining a reservation state of the passenger. The entrance and exit management system has a portable electronic identification card storing recognition codes of a person having the portable electronic identification card and making a communication with an external device through a Bluetooth communication module and a contact-type communication port or a wired communication port, a plurality of communication modules installed in an entrance region while forming a predetermined interval therebetween so as to communicate with the Bluetooth module and either communication port, a terminal for checking a personal identity, and an entrance and exit management server receiving the recognition codes to compare them with pre-registered information.

### TECHNICAL FIELD

The present invention relates to an entrance and exit management system using an electronic identification card, and more particularly to an entrance and exit management system allowing passengers having a reservation ticket to instantly get into an airplane, a ship, or an express bus by automatically ascertaining a reservation state of passengers, thereby saving time and preventing an airport, a wharf, or an express terminal from being crowded with people.

### BACKGROUND ART

As generally known in the art, in order to get into an airplane, a ship, or an express bus on a reservation date, passengers having a reservation ticket have to check their reservation state, exchange an air ticket with a boarding pass in the case of an airplane, and go through predetermined boarding procedures at an airport, a wharf or an express terminal. That is, a person makes a reservation to an airline company through a travel agency or an Internet in order to get on the airplane on a reservation date. Then, the person gets on the airplane in the airport on the reservation date after following predetermined boarding and departure procedures.

In order to follow the boarding and departure procedures, various steps, such as real name identification, reservation state conformation, and personal identity checking steps, are required. Therefore, not only are many people crowd at a check-in desk, but also it takes a long time to finish the boarding and departure procedures.

That is, a person obtains a boarding pass from the check-in desk by presenting an air ticket and a passport to the check-in desk, pays a passenger service charge, makes a declaration at customs, transmits freight, and takes a departure permit.

Accordingly, the person is required to arrive at the airport at least two hours before the departure so as to follow the boarding and departure procedures. Then, the person waits for the departure in a passenger waiting room. In addition, since many people stand in queues awaiting their turn for the boarding and departure procedures, it takes a long time to finish the boarding and departure procedures. Accordingly, it is difficult to get on the airplane if the person does not arrive at the airport at least two hours before the departure.

However, since the passenger making a reservation for an airplane is required to arrive at the airport at least two hours before the departure on the reservation date for following the boarding and departure procedures, a time waste problem has been caused. That is, the person, who arrives at the airport at least two hours before the departure, can finish the boarding and departure procedures in a short time. In this case, the person has nothing to do, so the person spends time in the passenger waiting room in vain, resulting the time waste.

Since many people are subject to the same boarding and departure procedures in the airport, the total time waste is remarkably increased. For example, if a hundred thousand of people use the airport per a day, two hundred thousand hours are wasted per a day, causing a great waste of time for people.

### DISCLOSURE OF THE INVENTION

Accordingly, the present invention has been made to solve the above-mentioned problems occurring in the prior art, and an object of the present invention is to provide an entrance and exit management system using an electronic identification card capable of allowing passengers, who make a reservation for an airplane, to get into the airplane, even if passengers arrive at an airport during the remaining few minutes before the departure, by rapidly carrying out the boarding and departure procedures.

Another object of the present invention is to provide an entrance and exit management system capable of notifying a departure time to the passengers by inspecting the passengers positioned in the airport and capable of checking whether or not the passengers get into the airplane.

In order to accomplish these objects, there is provided an entrance and exit management system comprising a portable recognition module storing recognition codes of a person having the portable recognition module and making a communication with an external device through a Bluetooth communication module, a plurality of Bluetooth communication modules installed in an access road of an airport while forming a predetermined interval therebetween so as to make a communication with the Bluetooth communication module of the portable recognition module, and a central computer receiving communication signals from the Bluetooth communication modules to compare the communication signals with reservation information stored in a memory or a hard disc thereof, thereby ascertaining a reservation state and a personal identity of the person.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing a layout of an airport equipped with an entrance and exit management system according to one embodiment of the present invention;

FIG. 2 is a block view showing a construction of the entrance and exit management system shown in FIG. 1;

FIG. 3A is a block view showing a construction of an electronic identification card according to one embodiment of the present invention;

FIG. 3B is a flow chart showing an operation order of an electronic identification card according to one embodiment of the present invention;

FIG. 4A is a flow chart showing a departure procedure by using an entrance and exit management system according to one embodiment of the present invention;

FIG. 4B is a flow chart showing an entry procedure by using an entrance and exit management system according to one embodiment of the present invention;

FIGS. 5A and 5B are views showing a construction and a flow chart of an entrance and exit control device using an electronic identification card according to one embodiment of the present invention, respectively; and

FIG. 6 is a flow chart showing a personal identity checking procedure by using an electronic identification card according to one embodiment of the present invention.

### BEST MODE FOR CARRYING OUT THE INVENTION

Hereinafter, a preferred embodiment of the present invention will be described with reference to the accompanying drawings. In the following description and drawings, the same reference numerals are used to designate the same or similar components, and so repetition of the description on the same or similar components will be omitted.

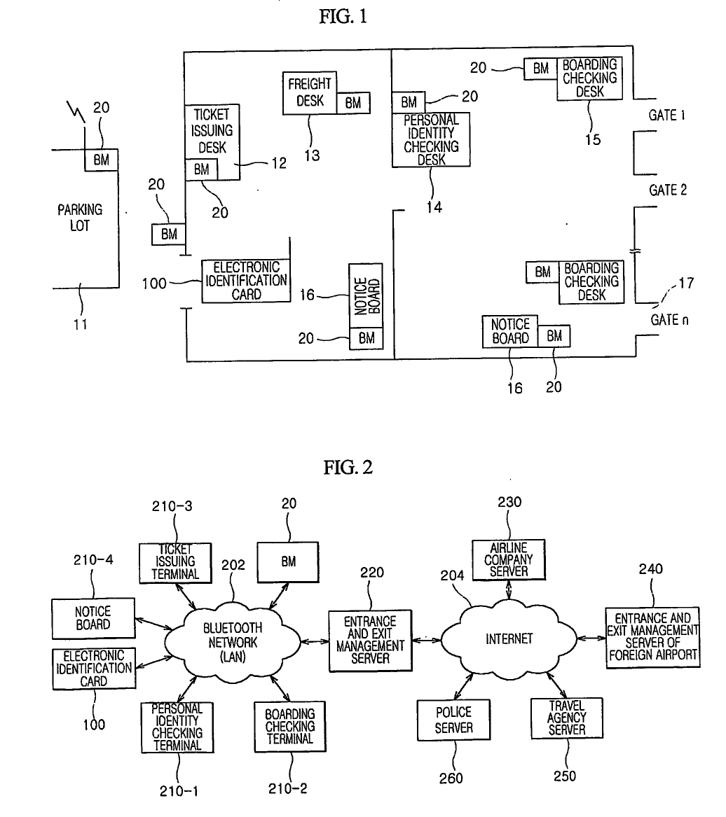

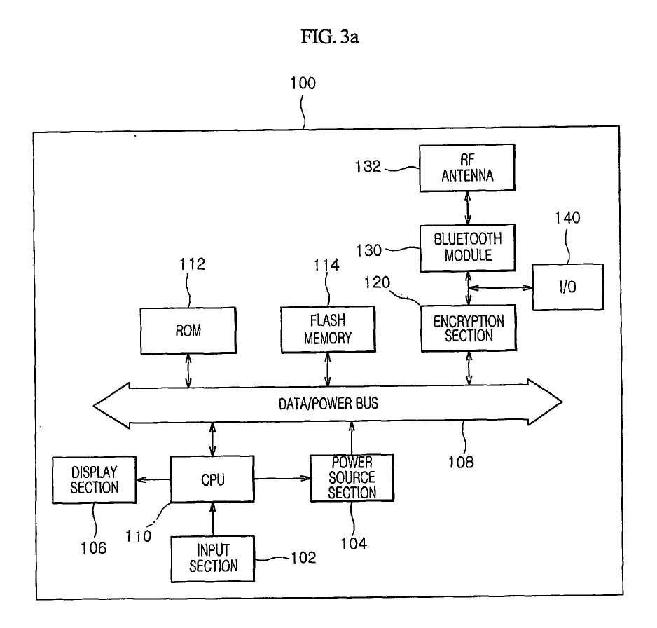

FIG. 1 is a schematic view showing a layout of an airport equipped with an entrance and exit management system according to one embodiment of the present invention. A plurality of BMs (Bluetooth communication modules) 20 are installed in various spots of a parking lot 11 and internal regions of an airport in order to make wireless communication between an electronic identification card 100 of a user and an entrance and exit management server 220 (shown in FIG. 2), which is a central computer of the airport. In the present embodiment, various kinds of user's identity checking desks are aligned in various spots of the airport. However, the user's identity checking work can be carried out in one desk.

Referring to FIG. 1, a ticket issuing desk 12 for issuing a boarding pass to passengers, a freight desk 13 for transmitting freight, a personal identity checking desk 14 for checking a personal identity of the passengers, boarding checking desks 15 for checking passengers boarded into an airplane through each gate 17, and notice boards 16 for providing various information to the passengers. Computer terminals (210-1 to 210-4 shown in FIG. 2) connected to the entrance and exit management server 220 through cables or wireless manner are aligned in each desk. According to the present embodiment, each computer terminal 210-1 to 210-4 is communicated with the electronic identification card 100 in Bluetooth communication manner, so each computer terminal has the Bluetooth communication module 20. The Bluetooth communication module 20 is installed in various spots of the airport including the notice boards 16, forming a wireless LAN.

In addition, the Bluetooth communication modules 20 are aligned in an access road of the airport and the parking lot 11 with a predetermined interval, so the entrance and exit management server 220 can check a reservation state and personal identity of the passenger by comparing a communication signal transmitted from the

Bluetooth communication modules 20 with reservation information, which is stored in a memory or a hard disc of the entrance and exit management server 220. Reservation information is inputted by the passenger when the passenger makes a reservation through a travel agency or an Internet. If the passenger makes the reservation through the travel agency, a worker of the travel agency inputs reservation information into the entrance and exit management server 220 of the airport. If the passenger makes the reservation through the Internet, the passenger inputs reservation information into the entrance and exit management server 220 of the airport.

FIG. 2 is a block view showing a construction of the entrance and exit management system shown in FIG. 1 a personal identity checking terminal 210-1, a boarding checking terminal 210-2, a ticket issuing terminal 210-3, and a notice board 210-4, which are installed in each desk, and the electronic identification card 100 are connected to the entrance and exit management server 220 through a Bluetooth wireless network 202. In addition, the entrance and exit management server 220 is connected to an entrance and exit management server 240 installed in an airport of a foreign country, an airline company server 230, a travel agency server 250 and a police server 260 through a wire/wireless communication network 204, such as the Internet. Although the present embodiment describes the terminals 210-1 to 210-3 and the notice board 210-4 as being connected to the entrance and exit management server 220 through the Bluetooth wireless network 202, it is also possible to connect the terminals 210-1 to 210-3 and the notice board 2104 to the entrance and exit management server 220 through a separate wireless LAN and a coaxial cable or an optical fiber cable LAN, such as an Ethernet.

As mentioned above, a plurality of Bluetooth communication modules 20 are installed throughout the whole area of the airport and departure area where passengers get into the airplane, so information of the portable electronic identification card 100 is transmitted into the entrance and exit management server 220 through the Bluetooth communication modules 20. As a result of communication between the portable electronic identification card 100 and the Bluetooth communication modules 20, information notifying a present position of the passenger is stored in the entrance and exit management server 220.

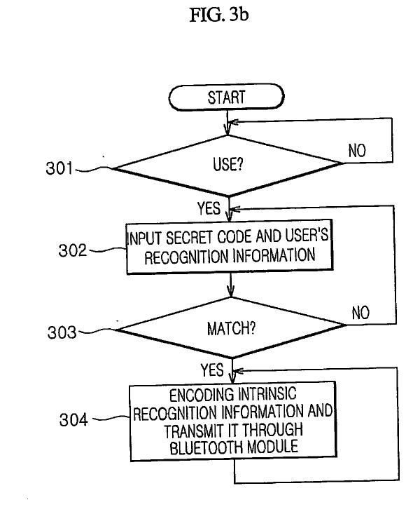

As shown in FIG. 3A, the portable electronic identification card 100 includes an input section 102, a power source section 104, a display section 106, a data/power bus 108, a CPU 110, a ROM 112, a flash memory 114, a code processing section 120, a Bluetooth communication module 130, an RF antenna 132 and an input/output section 140. That is, the Bluetooth communication module 130 is accommodated in the portable electronic identification card 100 together with a battery and the CPU 110, the ROM 112 and the flash memory 114 are installed in the portable electronic identification card 100 in order to transmit/receive information into/from the entrance and exit management server 220 in a bidirectional Bluetooth communication manner.

In order to make a communication between the Bluetooth communication module 130 and the CPU 110, a data processing device, such as a MODEM ASIC, or a communication relay is required. In addition, recognition codes of the user, such as personal identity information, military service information required for the departure, and crime records, are stored in the flash memory 114 or a RAM. Recognition information recorded in the electronic identification card 100 includes personal identity information recorded in a resident registration card, driver's license information, and passport information. If necessary, the user can selectively output a predetermined identification card through the input section 102.

The Bluetooth communication modules 130 and 20 can make a communication with each other within a distance of 100 m, so it is required to properly set the distance between the Bluetooth communication modules 20 when installing the Bluetooth communication modules 20 in the airport in such a manner that the Bluetooth communication modules 20 are prevented from being disturbed from each other. In addition, the Bluetooth communication modules 20 use about thousand channels, through which the Bluetooth communication module 130 installed in the portable communication card 100 makes a communication with the Bluetooth communication modules 20 installed in the airport.

In order to prevent other persons from using the electronic identification card 100 when the user loses the electronic identification card 100, a secret code switch for setting a user's secret code is formed in the electronic identification card 100. In addition, bio-information including fingerprint information and iris information is inputted into the electronic identification card 100 through the input section 102. The electronic identification card 100 has an encryption section 120 for encoding authentication information recorded in the electronic identification card 100 when making a communication with an external device, such as the entrance and exit management server 220. Thus, information transferred between the electronic identification card 100 and the external entrance and exit management server 220 is encoded, so hacking or wiretapping of information is impossible.

The CPU 110 controls an operation of the electronic identification card 100 based on an input source inputted into the input section 102 by executing software stored in a memory thereof. In order to reduce power consumption of the battery, the CPU 110 controls electric power supplied into each component of the electronic identification card 100 by controlling the power source section 104. As shown in FIG. 3B, when the electronic identification card 100 is used, a secret code or bio-information for ascertaining the user is inputted (steps 301 and 302). If the secret code of bio-information matches with a predetermined value, prerecorded intrinsic recognition information is encoded in the encryption section 120 and is transmitted into the RF antenna 132 through the Bluetooth communication module 130 (steps 303 and 304). If necessary, an operating state of the electronic identification card 100 is displayed in the display section 106.

The input/output section 140 includes a contact type wireless communication port or a wired communication port, such as USB or RS232C, which makes a communication with an external device in a wire/wireless manner if the Bluetooth communication module cannot make a communication with the external device. At this time, recognition information outputted through the input/output section is encoded through the encryption section 120. Although the present embodiment describes the Bluetooth communication modules as a communication medium, other security modules can be used as the communication medium.

The display section 106 displays the operating state of the electronic identification card 100 and displays various information through bi-directionally communicating with the external device (server). Although it is not illustrated in the drawings, an ear microphone can be provided to make a bi-directional communication with a manager of the server.

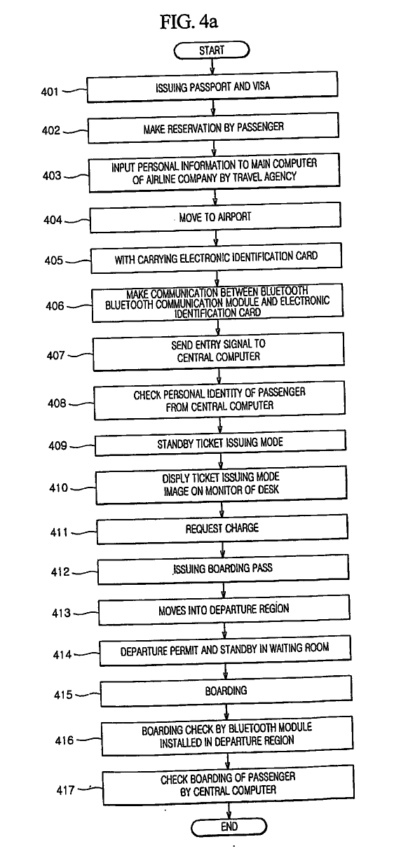

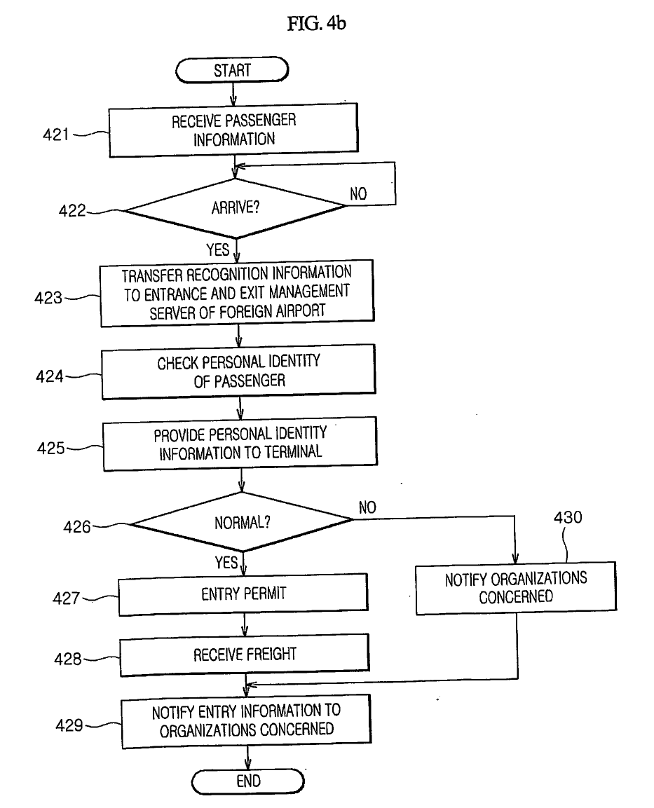

Hereinafter, an operation of the present invention will be described below with reference to FIGS. 4A and 4B.

FIG. 4A is a flow chart showing a departure procedure by using an entrance and exit management system according to one embodiment of the present invention.

Firstly, a passport or a VISA (if necessary) is issued (step 401). At this time, VISA issuing information is transferred to relating servers including the entrance and exit management server 220 through the Internet 204. The passenger makes a reservation for an airplane through the travel agency or the Internet. At this time, the passenger or the travel agency inputs personal information of the passenger into a main computer of the airline company or the entrance and exit management server 220 (steps 402 and 403).

With the approach of a boarding time, the passenger having the electronic identification card 100 enters into the access road of the airport, so the portable electronic identification card 100 makes a communication with the Bluetooth communication modules 20 installed in the access road of the airport (step 404 to 406).

When the portable electronic identification card 100 makes the communication with the Bluetooth communication modules 20 installed in the access road of the airport, recognition information including personal information stored in the flash memory 114 or the RAM of the portable electronic identification card 100 is transmitted into the entrance and exit management server 220 through the Bluetooth communication modules 20 (step 407).

At this time, the Bluetooth communication modules 20 installed in the access road or the parking lot of the airport are sequentially communicated with the portable electronic identification card 100 as the passenger moves. Thus, it is known whether the passenger moves into the airport or moves out of the airport based on the movement of the portable electronic identification card 100 communicated with the Bluetooth communication modules 20.

When recognition codes are transmitted into the entrance and exit management server 220 from the portable electronic identification card 100 of the passenger, the entrance and exit management server 220 reads out reservation information stored therein so as to determine whether or not the present passenger is a person, who makes a reservation (step 408).

If the passenger is the person who made the reservation, the entrance and exit management server 220 sends reservation information to a ticket issuing terminal 210-3 of a check-in desk, where the passenger takes a boarding procedure. When the reservation information of a passenger who enters the airport, is transmitted into the ticket issuing terminal 210-3 of the check-in desk, the ticket issuing terminal 210-3 maintains a standby state for issuing the ticket (step 409). That is, a reservation status of the passenger is checked in advance while the passenger is being entered into the airport, and is transmitted into the ticket issuing desk 12 so as to allow the ticket issuing desk 12 to check whether the passenger makes the reservation and to compare the air ticket with the person having the air ticket.

Plural check-in desks, which are prepared by a plurality of airline companies, simultaneously maintain the standby state. In this state, the check-in desks wait for outputting the boarding pass or output the boarding pass in advance. In this case, the name of the passenger, who is an owner of the boarding pass outputted from the check-in desks, is displayed in an electric signboard.

Then, the passenger enters into an airport lounge and accesses to the ticket issuing desk 12. At this time, the Bluetooth communication module 20 installed in the ticket issuing desk 12 makes a communication with the Bluetooth communication module 130 of the electronic identification card 100 of the passenger. While the Bluetooth communication module 20 installed in the ticket issuing desk 12 is being communicated with the Bluetooth communication module 130 of the electronic identification card 100, personal information of the present passenger is searched based on recognition codes transmitted from the electronic identification card 100. If there is passenger information, which matches with information of the present passenger, passenger information of the present passenger is rapidly displayed on a monitor (step 410).

When passenger information is displayed on the monitor, a worker in charge of the ticket issuing desk compares passenger information described in the air ticket presented by the passenger with passenger information displayed on the monitor and checks a face of the passenger based on an image displayed on the monitor. If the passenger matches with the person, who makes the reservation, the worker requests a charge required for boarding the airplane to the passenger. Thus, the passenger pays the charge by means of a charge settlement device, a credit card or cash. Upon receiving the charge from the passenger, the worker outputs the boarding pass or gives the boarding pass outputted in advance to the passenger (step 411 and 412). At this time, since passenger information has been transmitted into organizations concerned and the entrance and exit management server 240 installed in the airport of the foreign country while issuing the VISA and making the reservation, the foreign country, where the passenger wants to enter, or the organizations concerned can notify an entry permit of the passenger to the airline company and the entrance and exit management server 220 of the domestic airport. If the entry permit of the passenger is rejected, the airline company notifies the rejection of the entry permit to the passenger in advance, thereby delaying or canceling the ticket issuing. Therefore, according to the present invention, the passenger can be prevented from being rejected in the course of entry into the foreign country and can take proper action in advance with respect to the rejection. In the case of a passenger who has the electronic identification card according to the present invention, it is preferred to omit the comparing step by the monitor in the course of the ticket issuing procedure, but the comparing step is carried out in the course of a boarding step or in one spot of the departure procedures.

The passenger receiving the boarding pass separately makes a declaration at customs, records completion of a military service, and transmits baggage. When the above procedures are carried out, the Bluetooth communication module 20 installed in each desk 13 is communicated with the Bluetooth communication module 140 installed in the electronic identification card 100 of the passenger, so the above procedures can be simply finished (step 413). That is, as the same manner as the ticket issuing procedure, when the passenger having the portable electronic identification card 100 accesses to each desk 13, the Bluetooth communication module 20 installed in each desk 13 makes a Bluetooth communication with the portable electronic identification card 100, so passenger information is displayed on an LCD monitor before the passenger reaches the desk 13. Thus, the inspector, who inspects the entrance/exit and personal identity of the passenger, only checks whether or not passenger information displayed on the LCD monitor matches with the passenger, so the inspection procedure is rapidly finished.

When the above boarding and departure procedures have been completed, the passenger moves into a departure region so as to take a departure permit in a personal identity checking desk. At this time, since passenger information is displayed on the personal identity checking terminal 210-1 based on the electronic identification card 100, the departure permit procedure is simply carried out based on passenger information displayed on the LCD monitor if the passenger presents the passport (step 414).

The passenger entered into the departure region instantly gets into the airplane without being waited in a lounge of the departure region, so a time required for getting into the airplane can be saved by tens of minutes. That is, the entrance and exit management system detects the passenger from an entrance of the airport so as to prepare procedures required for the passenger to get into the airplane, so the passenger can get into the airplane within a short time.

At this time, the Bluetooth communication modules 20 installed in the departure region make a communication with the portable electronic identification card 100 of the passenger, and the entrance and exit management server 220 checks whether or not the passenger safely gets into the airplane (step 415 and 416) through the Bluetooth communication modules 20. That is, if a distance between the Bluetooth communication modules 20 installed in the departure region is set narrow with lowering an output thereof for preventing an interruption therebetween, it is known whether or not the passenger has gotten on the airplane by inspecting a communication path between the portable electronic identification card 100 and the Bluetooth communication modules 20 in the departure region.

As described above, if the Bluetooth communication modules 20 are installed in the whole area of the airport with a predetermined interval, the Bluetooth communication modules 20 intermittently make a communication with the electronic identification card 100 of the passenger, so the present position of the passenger can be recognized through the entrance and exit management server 220 and the passenger can rapidly get into the airplane. That is, if the passenger is positioned in other gates or wrong places in the airport, information for guiding the passenger to a normal boarding route is displayed on the notice board 16 by using position information of the passenger, so the passenger can be moved into the normal boarding route.

Then, if the passenger passes through the gate, boarding information of the passenger is transmitted into the entrance and exit management server 220 through the boarding checking terminal 210-2, so the entrance and exit management server 220 transmits boarding information of the passenger to the server 230 of the airline company, the entrance and exit management server 240 installed in the airport of the foreign country, and a server of organizations concerned through the Internet 204 (steps 415 to 417). Accordingly, the personal identity of the passenger can be rapidly checked in the foreign airport, to which the passenger arrives.

FIG. 4B is a flow chart showing an entry procedure by using the entrance and exit management system according to one embodiment of the present invention.

After the departure procedure has been completed as shown in FIG. 4A, the passenger information is transmitted into the entrance and exit management server 240 of the foreign country from the entrance and exit management server 220 through the Internet 204 (step 421).

When the passenger arrives at an entry region of the foreign airport, the Bluetooth communication modules installed in the entry region of the foreign airport are communicated with the electronic identification card 100 of the passenger so that recognition information of the passenger is transmitted into the entrance and exit management server 240 of the foreign country. At this time, information regarding the visa issuance and information transmitted from Interpol are stored in the entrance and exit management server 240 of the foreign country.

The entrance and exit management server 240 of the foreign country search passenger information based on recognition information of the passenger transmitted from the electronic identification card 100, thereby ascertaining the personal identity and the visa (step 424). Then, ascertained passenger information is transferred to the terminal installed in the entry region of the foreign airport. Based on ascertained passenger information, the passenger takes an entry permit or is subject to a proper measure by organization concerned if ascertained passenger information is abnormal (steps 426, 427 and 430).

If the passenger takes the entry permit, the airline company allows the passenger to receive freight based on recognition information of the passenger. When the entry procedure has been completed, entry information of the passenger is transmitted into the server of the organizations concerned (step 429).

As described above, when the passengers have the portable electronic identification card 100, the portable electronic identification card 100 makes a communication with the entrance and exit management server 220 through the Bluetooth communication modules 20 so that recognition codes including the personal identity of the passengers are transmitted into the entrance and exit management server 220 in advance. Accordingly, the worker can rapidly inspect the passengers while displaying passenger information on the monitor provided in the desk, so the boarding, departure, and entry procedures are rapidly carried out while preventing the passenger from waiting for a long time. If the boarding, departure, and entry procedures are rapidly carried out, passengers do not require to wait for the boarding, departure, and entry procedures, thereby reducing waste of time. That is, if the boarding, departure, and entry procedures are finished in a short time, many passengers do not require to stand in queues awaiting their turn for the boarding, departure, and entry procedures, thereby reducing waste of time and preventing the passengers from waiting in the airport about two hours.

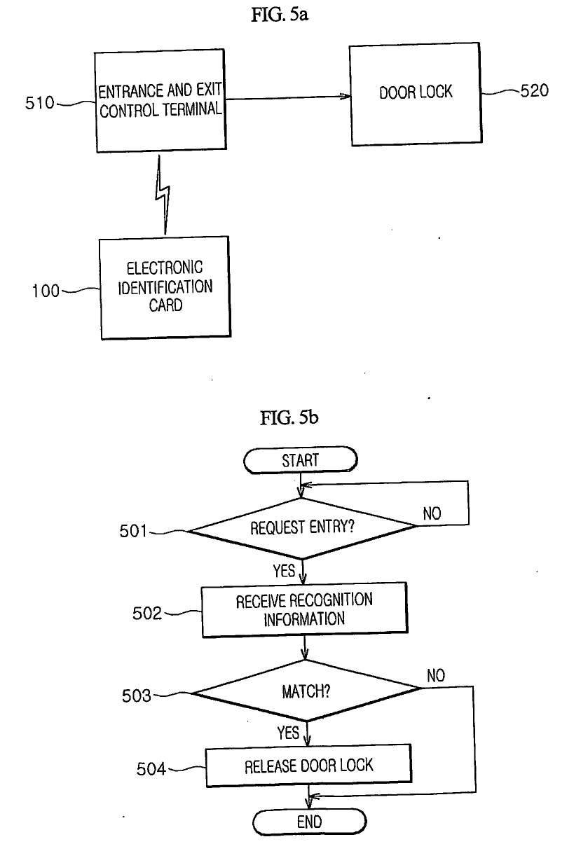

FIGS. 5A and 5B are views showing an example of an entrance and exit control device using the electronic identification card according to one embodiment of the present invention.

The electronic identification card of the present invention can be used in various fields including an apartment and an office. That is, as shown in FIG. 5A and 5B, an entrance and exit control terminal 510 capable of performing the Bluetooth communication is connected to a door-lock device 520. When a user having the electronic identification card 100 registered in the entrance and exit control terminal 510 accesses to the entrance and exit control terminal 510, a communication is carried out between the entrance and exit control terminal 510 and the electronic identification card 100 of the user. If the authentication is normally accepted, the entrance and exit control terminal 510 controls the door-lock device 520 to release the locking state of the door-lock device 520 (step 501 to 504). Thus, the user can easily entry/exit into/from a front door of the apartment equipped with locking equipment.

Besides the front door of an apartment, the entrance and exit management system of the present invention is suited for a door-lock device of a vehicle. In this case, door locking, door unlocking and ignition works are controlled by means of the electronic identification card of the present invention.

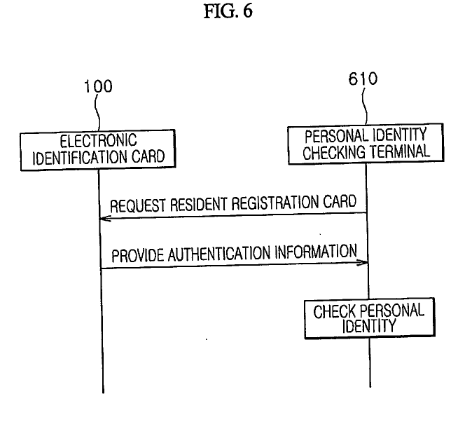

FIG. 6 is a flow chart showing a personal identity checking procedure by using the electronic identification card according to the present invention.

Referring to FIG. 6, when a police man having a personal identity checking terminal 610 capable of making a Bluetooth communication with the electronic identification card 100 suddenly checks up a person, the police man requires the person to present the resident registration card. At this time, the person having the electronic identification card 100 pushes a button installed in the electronic identification card 100 so as to make a Bluetooth type communication between the personal identity checking terminal 610 of the police man and the electronic identification card 100 of the person. When authentication information is transmitted into the personal identity checking terminal 610 trough the Bluetooth communication, the police man checks the personal identity of the person by using information displayed on the personal identity checking terminal 610. Accordingly, the personal identity checking work can be rapidly, easily and precisely carried out.

Although the present invention has been described with reference to the entrance and exit management system of the airport, the present invention can be suited for entrance and exit management systems of an intercontinental shipping terminal, an intercontinental bus terminal, and an intercontinental railroad terminal, where the passenger is required to make a reservation for using the facilities thereof.

When the entrance and exit management system including an entrance and exit management server, a plurality of Bluetooth modules and a portable electronic identification card is used for an entrance and exit control system of a general company, if a worker having the electronic identification card accesses to a door, the electronic identification card makes a communication with the Bluetooth communication modules so that a central computer controls the on/off state of the a door lock device based on a personal identity of the worker, thereby easily controlling the entrance and exit of the worker. Thus, a wireless entrance and exit security system can be achieved without using a fingerprint recognition system or a magnetic card.

According to the present invention, a person, who makes a reservation for an airplane, is not required to arrive at the airport two hours before the departure for receiving a boarding pass and for following the boarding and departure procedures. That is, it is enough for the person to arrive at the airport remaining tens of minutes before the departure because the personal identity of the person is automatically ascertained through a communication between a portable Bluetooth recognition module provided in the electronic identification card of the person and Bluetooth modules installed in the airport. Therefore, the boarding and departure procedures are simply carried out by checking the person based on personal information displayed on a monitor, so a time required for boarding and departure procedures is remarkably saved.

In addition, since a waiting time is remarkably reduced, passengers can instantly get into the airplane without waiting for a long time in the waiting room, so it is not required to construct the waiting room in a large size, so that a space of the airport can be efficiently utilized. In addition, since the portable recognition module continuously makes a communication with the Bluetooth modules installed in various spots of the airport, the position of the passenger in the course of the boarding and departure procedures can be easily detected.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention can be effectively applied to an entrance and exit management system of an airport and a wharf, where many people are crowded so that an entrance and exit control is required. In addition, the present invention is also suited for an attendance and leaving management system and a security system of a company and an entrance and exit control system of an apartment or a place requiring the security. In addition, the present invention can be used for inspecting the personal identity of a person without requiring various kinds of identification cards.

What is claimed:

1. (canceled)

2. (canceled)

3. An entrance and exit management system comprising:
a portable electronic identification card storing recognition codes of a person having the portable electronic identification card and making a communication with an external device through a Bluetooth communication module and a contact-type communication port or a wired communication port;
a plurality of communication modules installed in an entrance region while forming a predetermined interval therebetween so as to make a communication with the Bluetooth communication module and the contact-type communication port or the wired communication port of the portable electronic identification card;
a terminal for checking a personal identity of the person entered into the entrance region; and
an entrance and exit management server receiving the recognition codes stored in the portable electronic identification card from the Bluetooth communication modules to compare the recognition codes with pre-registered information, thereby ascertaining a reservation state and the personal identity of the person, and transmitting ascertained information to the terminal.
wherein the entrance and exit management system further comprises a notice board for providing guide information to the person having the portable electronic identification card through the bi-directional communication between the portable electronic identification card and the Bluetooth communication modules.

4. An entrance and exit management system comprising:
a portable electronic identification card storing recognition codes of a person having the portable electronic identification card and making a communication with an external device through a Bluetooth communication module and a contact-type communication port or a wired communication port;
a plurality of communication modules installed in an entrance region while forming a predetermined interval therebetween so as to make a communication with the Bluetooth communication module and the contact-type communication port or the wired communication port of the portable electronic identification card;
a terminal for checking a personal identity of the person entered into the entrance region; and
an entrance and exit management server receiving the recognition codes stored in the portable electronic identification card from the Bluetooth communication modules to compare the recognition codes with pre-registered information, thereby ascertaining a reservation state and the personal identity of the person, and transmitting ascertained information to the terminal,
wherein the portable electronic identification card includes a memory for storing predetermined recognition information, an encryption section connected to the Bluetooth communication modules to decode data transferred from the Bluetooth communication modules, and a CPU for controlling recognition information stored in the memory to be transferred to the entrance and exit management server through the encryption section and the Bluetooth communication modules according to a predetermined procedure.

5. The entrance and exit management system as claimed in claim 4, wherein the portable electronic identification card includes an input section for inputting a secret code or user's information so as to prevent other person from using the portable electronic identification card when the person loses the portable electronic identification card, and the CPU controls the portable electronic identification card to be operated only when the secret code or user's information inputted into the input section matches with a predetermined secret code or user's information.

6. An entrance and exit management system comprising:
a portable electronic identification card storing recognition codes of a person having the portable electronic identification card and making a communication with an external device through a Bluetooth communication module and a contact-type communication port or a wired communication port;
a plurality of communication modules installed adjacent to a door so as to make a communication with the Bluetooth communication module and the contact-type communication port or the wired communication port of the portable electronic identification card; and
a central computer for controlling an on/off state of a locking device of the door by comparing information transmitted from the communication modules with predetermined information stored therein.
